(19) United States
(12) Patent Application Publication
(10) Pub. No.: US 2022/0021773 A1
(43) Pub. Date: Jan. 20, 2022

(54) INFORMATION PROCESSING APPARATUS, METHOD FOR ADJUSTING OPERATION OF INFORMATION PROCESSING APPARATUS, AND STORAGE MEDIUM

(71) Applicant: Konica Minolta, Inc., Chiyoda-ku (JP)

(72) Inventor: Yukio WATANABE, Hachioji-shi (JP)

(73) Assignee: Konica Minolta, Inc., Chiyoda-ku (JP)

(21) Appl. No.: 17/377,660

(22) Filed: Jul. 16, 2021

(30) Foreign Application Priority Data
Jul. 17, 2020 (JP) 2020-122482

(51) Int. Cl. H04N 1/00; G06F 3/01; G06F 3/16

(52) U.S. Cl. CPC H04N 1/00488; G06F 3/165; G06F 3/016; H04N 1/00411

(57) ABSTRACT

An information processing apparatus includes: a display with a touchscreen; a vibrator configured to perform a vibration action of vibrating an operation surface of the touchscreen; a notification sound outputter configured to perform a notification-sound output action of outputting a notification sound; a storage that stores response setting information on whether the vibration action and the notification-sound action are enabled; and a hardware processor that causes the vibrator and/or the notification sound outputter to perform the vibration action and/or the notification-sound output action enabled in the response setting information in response to a touch operation on the operation surface. The hardware processor adjusts a vibration intensity of the vibration action and a sound volume of the notification-sound output action according to at least either the response setting information or an operating state of the information processing apparatus.

### CROSS-REFERENCE TO RELATED APPLICATIONS

The entire disclosure of Japanese Patent Application No. 2020-122482 filed on Jul. 17, 2020 is incorporated herein by reference in its entirety.

### TECHNOLOGICAL FIELD

The present disclosure relates to an information processing apparatus, a method for adjusting operation of an information processing apparatus, and a storage medium.

### DESCRIPTION OF RELATED ART

There is known a technique of providing an information processing apparatus with a display that has a touchscreen. The display displays various contents and receives input operations corresponding to the display contents on the touchscreen. Such a technique is applied not only to portable devices (e.g., smartphone and tablet) but also to input devices that are for stationary apparatuses, such as an image forming apparatus (e.g., printer or multi-functional peripheral), and that receive users' operation (for example, disclosed in JP2008-276278A).

According to JP2008-276278A, an information processing apparatus includes a vibrator that vibrates the operation surface of the touchscreen and a notification-sound outputter that outputs a notification sound. The information processing apparatus responds to a touch operation by vibrating the operation surface with the vibrator or by outputting the notification sound.

### SUMMARY

The audibility of the notification sound depends on the environment in which the information processing apparatus operates. Depending on the environment, the notification sound may not be audible due to other sounds or may be too loud and annoying. When the vibration intensity of the vibrator is increased without considering the audibility of the notification sound so as to certainly transmit a response to a touch operation to the user, the vibration may be too strong and annoying.

The above known art thus may not appropriately set the volume of the notification sound and the vibration intensity of the vibrator.

Objects of the present invention include providing an information processing apparatus, a method for adjusting operation of an information processing apparatus, and a storage medium storing a program that can appropriately set the volume of the notification sound and the vibration intensity of the vibrator.

To achieve at least one of the abovementioned objects, according to an aspect of the present invention, there is provided An information processing apparatus including: a display with a touchscreen; a vibrator configured to perform a vibration action of vibrating an operation surface of the touchscreen; a notification sound outputter configured to perform a notification-sound output action of outputting a notification sound; a storage that stores response setting information on whether the vibration action and the notification-sound action are enabled; and a hardware processor that causes the vibrator and/or the notification sound outputter to perform the vibration action and/or the notification-sound output action enabled in the response setting information in response to a touch operation on the operation surface, wherein the hardware processor adjusts a vibration intensity of the vibration action and a sound volume of the notification-sound output action according to at least either the response setting information or an operating state of the information processing apparatus.

According to another aspect of the present invention, there is provided a method for adjusting an operation of an information processing apparatus that includes: a display with a touchscreen; a vibrator configured to perform a vibration action of vibrating an operation surface of the touchscreen; a notification sound outputter configured to perform a notification-sound output action of outputting a notification sound; and a storage storing response setting information on whether the vibration action and the notification-sound action are enabled, the method including: adjusting a vibration intensity of the vibration action and a sound volume of the notification-sound output action according to at least either the response setting information or an operating state of the information processing apparatus; and causing the vibrator and/or the notification sound outputter to perform the vibration action and/or the notification-sound output action enabled in the response setting information in response to a touch operation on the operation surface.

According to another aspect of the present invention, there is provided a non-transitory computer-readable storage medium storing a program that causes a computer of an information processing apparatus including: a display with a touchscreen; a vibrator configured to perform a vibration action of vibrating an operation surface of the touchscreen; a notification sound outputter configured to perform a notification-sound output action of outputting a notification sound; and a storage storing response setting information on whether the vibration action and the notification-sound action are enabled, to function as a hardware processor that causes the vibrator and/or the notification sound outputter to perform the vibration action and/or the notification-sound output action enabled in the response setting information in response to a touch operation on the operation surface and adjusts a vibration intensity of the vibration action and a sound volume of the notification-sound output action according to at least either the response setting information or an operating state of the information processing apparatus.

### BRIEF DESCRIPTION OF THE DRAWINGS

The advantages and features provided by one or more embodiments of the invention will become more hilly understood from the detailed description given hereinbelow and the appended drawings which are given by way of illustration only, and thus are not intended as a definition of the limits of the present invention, wherein:

FIG. 1 is a diagram showing a schematic configuration of an image forming apparatus;

FIG. 2 shows a configuration of an image former;

FIG. 3 is a sectional view of an operation display unit;

FIG. 4 is a block diagram showing main functional components of the image forming apparatus;

FIG. 5 is a response setting screen;

FIG. 6A, 6B, 6C, 6D each show an example of contents of response setting data;

FIG. 7 shows control procedure of a default value setting process;

FIGS. 8A, 8B each show a set-value change window for receiving operation of adjusting the vibration intensity and sound volume by the user;

FIG. 9 shows response setting data that records set values to which additional values have been added;

FIG. 10 is a figure to explain how the set values of the vibration intensity and the sound volume are corrected according to the level of ambient sound;

FIG. 11 is a figure to explain how the set values are corrected with a set-value correction table;

FIG. 12 is a flowchart showing control procedure of a response process that is performed by a controller and that includes correcting the set values according to ambient sound;

FIGS. 13A, 13B, 13C are figures to explain how the set values are corrected with a set-value addition table; and

FIG. 14 is a flowchart showing control procedure of a response process that includes correcting the set values according to an operating state of the image forming apparatus.

### DETAILED DESCRIPTION OF THE EMBODIMENTS

Hereinafter, one or more embodiments of an information processing apparatus, a method for adjusting operation of an information processing apparatus, and a storage medium are described with reference to the drawings. However, the scope of the invention is not limited to the disclosed embodiments.

[Configuration of Image Forming Apparatus]

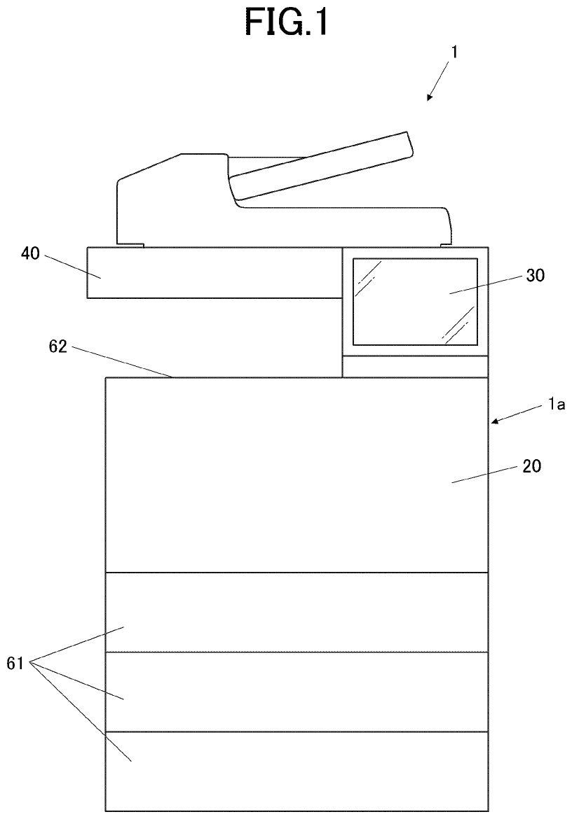

FIG. 1 is a schematic configuration of an image forming apparatus 1 in an embodiment of the present invention.

The image forming apparatus 1 (information processing apparatus) is an electrophotographic multi-functional peripheral that forms color images. The image forming apparatus 1 includes a housing 1a, an image former 20, an operation display unit 30, a scanner 40, a sheet feeding tray 61, and a sheet receiving tray 62. The image former 20 and the scanner 40 are processing performers that perform certain processing that involves outputting at least either processing sounds or vibration.

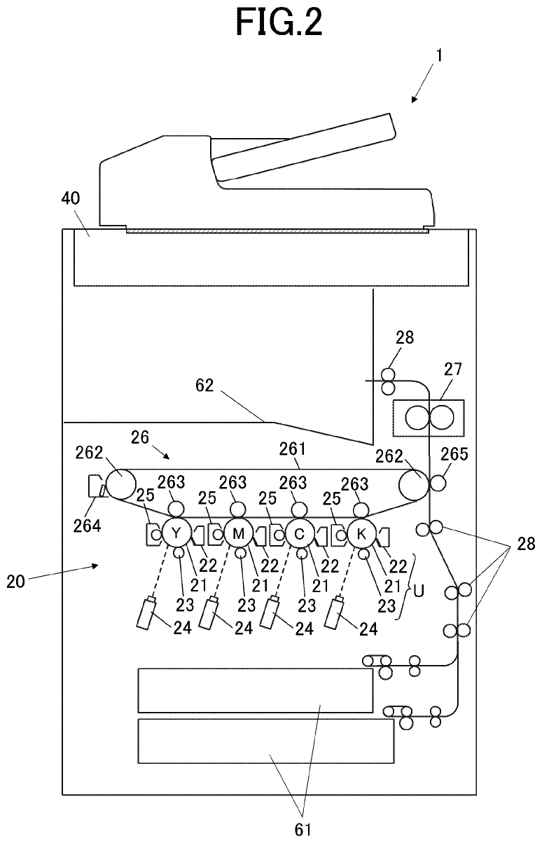

FIG. 2 is a configuration of the image former 20.

The image former 20 is housed in the housing 1a. The image former 20 hums images on sheets (recording media) fed from the sheet feeding tray 61 and ejects the sheets to the sheet receiving tray 62. The image former 20 that performs image forming operation is a processing performer that performs processing that involves outputting both processing sounds and vibration.

The image former 20 includes: image carriers 21 each of which is a drum-type photoconductor to carry an electrostatic latent image(s) on its surface; cleaners 22 each of which removes residual toner on the surface of the corresponding image carrier 21; charging rollers 23 each of which uniformly charges the surface of the corresponding image carrier 21; exposing units 24 each of which forms the electrostatic latent image by exposing the charged surface of the corresponding image carrier 21; developing units 25 each of which develops the electrostatic latent image on the surface of the corresponding image carrier 21 using a developer containing toner, thereby forming a toner image; a transfer unit 26 that firstly transfers the formed toner images onto an intermediate transfer belt 261 in the transferring region and that secondarily transfers the YMCK toner image on the intermediate transfer belt 261 onto a sheet; a fixing unit 27 that fixes the YMCK toner image to the sheet; and conveying rollers 28 that convey the sheet along a conveying path from the sheet feeding tray 61 to the sheet receiving tray 62. Among the above components, the image carrier 21, the cleaner 22, the charging roller 23, the exposing unit 24, and the developing unit 25 constitute an imaging unit.

The image former 20 has four imaging units for colors of yellow (Y), magenta (M), cyan (C), and black (K). The imaging units are arranged in the order of Y, M, C, and K along the bottom plane surface of the intermediate transfer belt 261. In each imaging unit, the cleaner 22, the charging roller 23, the exposing unit 24, and the developing unit 25 are arranged in this order along the outer circumferential surface of the image carrier 21.

The image carrier 21 rotates on an axis. The image carrier 21 has a photosensitive layer on its outer circumferential surface.

The cleaner 22 has a plate-shaped cleaning blade formed of an elastic material. The cleaner 22 causes the cleaning blade to abut the surface of the image carrier 21, so that foreign substances on the surface of the image carrier 21, such as residual toner that has not been transferred to the intermediate transfer belt 261, are removed.

The charging roller 23 is a cylindrical member. The charging roller 23 abuts the surface of the image carrier 21 and rotates on an axis according to the rotation of the image carrier 21. The charging roller 23 receives charge-driving voltage from a not-shown power source to uniformly charge the surface of the image carrier 21.

The exposing unit 24 includes a laser diode (LD) as a light-emitting element. The exposing unit 24 irradiates and exposes, with laser light, the surface of the image carrier 21 charged by the charging roller 23 and thereby forms an electrostatic latent image on the image carrier 21.

The developing unit 25 includes a developing sleeve (developing roller) that is positioned so as to face the surface of the image carrier 21. The developing unit 25 supplies the developer containing toner, which is supplied from a not-shown toner bottle, to the surface of the developing sleeve that has a certain developing-bias potential, so that the toner on the surface of the developing sleeve adheres to the electrostatic latent image on the surface of the image carrier 21. The developing unit 25 thus forms a toner image on the surface of the image carrier 21.

The transfer unit 26 includes: two belt-conveying rollers 262; four first transfer rollers 263 positioned so as to face the corresponding image carriers 21; the intermediate transfer belt 261 stretched around the belt-conveying rollers 262 and the first transfer rollers 263; a belt cleaner 264 that removes residual toner on the intermediate transfer belt 261; and a second transfer roller 265 that is pressed against one of the belt-conveying rollers 262 and driven to rotate as the belt-conveying roller 262 rotates.

The transfer unit 26 rotally moves the intermediate transfer belt 261 while applying, to the first transfer rollers 263, bias voltage the polarity of which is reverse to that of the toner, so that the toner on the surface of the rotating image carriers 21 is transferred to the intermediate transfer belt 261. After transferring the toner images of Y, 1\4, C and K on the intermediate transfer belt 261 such that the toner images are superposed on one another, the transfer unit 26 causes a sheet to pass through between the intermediate transfer belt 261 and the second transfer roller 265 to which predetermined bias voltage is applied. Accordingly, the color toner image on the intermediate transfer belt 261 is transferred onto the sheet. The residual toner on the intermediate transfer belt 261 that has not been transferred onto the sheet is removed by the cleaning blade of the belt cleaner 264.

The fixing unit 27 heats and pressurizes the sheet on which the toner image has been transferred to fix the toner image to the sheet. The fixing unit 27 includes a pair of rollers constituted of a heating roller and a pressure roller to hold the sheet. The sheet to which the toner image has been fixed is conveyed by the conveying roller 28 to the sheet receiving tray 62.

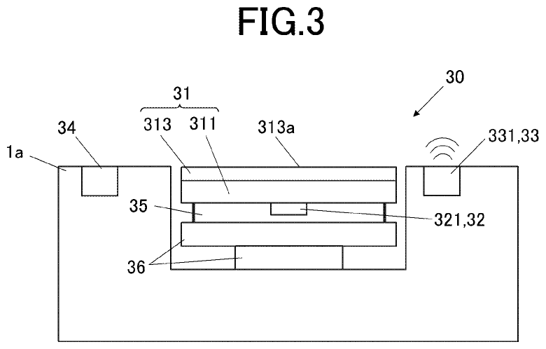

FIG. 3 is a sectional view of an operation display unit 30.

The operation display unit 30 includes a display 31, a vibrator 32, a notification-sound outputter 33, a sound collector 34 (ambient sound detector), a vibration absorber 35, and a fixing member 36.

The display 31 includes a display panel 311 and a touchscreen 313.

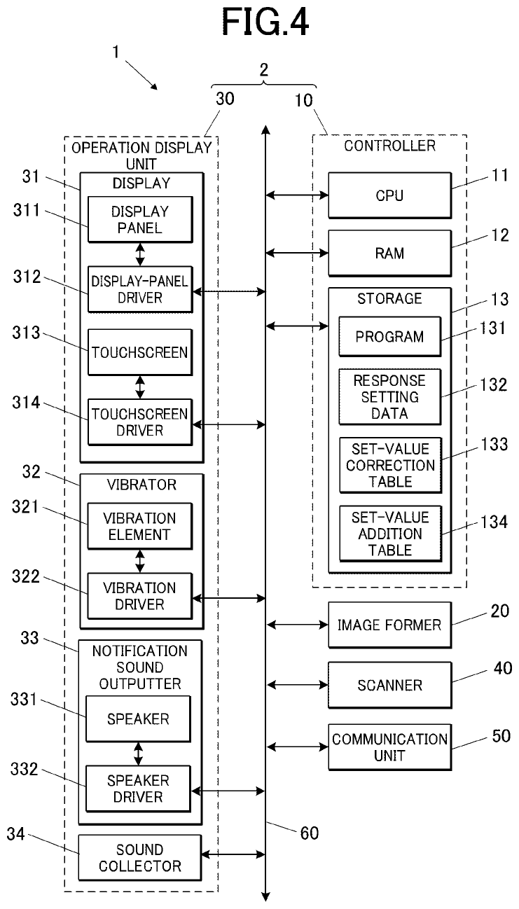

The display panel 311 can be a liquid crystal display, for example, but not limited thereto. The display panel 311 may be other types of display, such as an organic electroluminescent display. The display panel 311 is driven by a display-panel driver 312 in FIG. 4 under the control of a controller 10 in FIG. 4 to display various windows. The various windows include: an operation window that shows operation buttons on which touch operations are performed via the touchscreen 313; and a state window that shows the state of the image forming apparatus 1.

The touchscreen 313 is laid on the display panel 311 as one body. The touchscreen 313 has an operation surface 313a that is superimposed on the display region of the touchscreen 313. The touchscreen 313 detects a touch of an operation tool, such as the user's finger or a stylus, on the operation surface 313a and detects the touched positions. The touchscreen 313 may detect the position touched with the operation tool on the basis of change in electrostatic capacitance of the touchscreen 313, for example (electrostatic capacitance type). The touchscreen 313 is not limited to the electrostatic capacitance type but may be a resistance film type that detects the position touched with the operation tool according to connections between electrodes.

The vibrator 32 has a vibration element 321 that converts electric signals into physical vibration. The vibration element 321 is attached to the back surface of the touchscreen 313. The vibration element 321 is driven to vibrate by the vibration driver 322 shown in FIG. 4 under the control of the controller 10. The vibration of the vibration element 321 is transmitted to the operation surface 313a via the display panel 311 and the touchscreen 313. When the user's finger (operation tool) is in contact with the operation surface 313a at the time the vibration is transmitted to the operation surface 313a, the user senses the vibration as a vibration response from the operation display unit 30. The vibrator 32 with the vibration element 321 thus performs the vibration action of vibrating the operation surface 313a of the touchscreen 313. The vibration element 321 is vibrated at the intensity corresponding to the voltage value of the voltage waveform (driving waveform) of driving signals applied by the vibration driver 322. The vibration intensity can be adjusted with the voltage value of the driving signals.

The position of the vibration element 321 and the method of vibrating the vibration element 321 are not limited to the above. The vibration element 321 may be attached to the front surface of the touchscreen 313 of the display panel 311 so as not to overlap the display region, for example.

The notification-sound outputter 33 includes a speaker 331 that outputs a predetermined notification sound. The speaker 331 is positioned so as to output the notification sound towards the front side of the image forming apparatus 1. The speaker 331 is driven by the speaker driver 332 to output the notification sound under the control of the controller 10. More specifically, when a touch operation on the operation surface 313a is detected, the controller 10 activates the speaker driver 332 to output the notification sound from the speaker 331. The user senses the notification sound as a sound response (touch sound) to the touch operation. Thus, the notification-sound outputter 33 that includes the speaker 331 performs the notification-sound output action of outputting the notification sound. The speaker 331 outputs the notification sound at a volume corresponding to the voltage value of the driving waveform applied by the speaker driver 332. The vibration intensity can be adjusted with the voltage value of the driving signals.

The sound collector 34 detects the level of the ambient sound and outputs the detection result to the controller 10. The sound collector 34 is a microphone, for example. The sound collector 34 converts the vibration amount of the diaphragm caused by the ambient sound into voltage signals and outputs the signals.

The vibration absorber 35 is positioned between the back surface of the display 31 and the fixing member 36. The vibration absorber 35 prevents the vibration of the display 31, which is caused by the vibration action of the vibrator 32, from being transmitted to the fixing member 36.

The fixing member 36 is attached to the display 31 with the vibration absorber 35 in between and fixed to the housing 1a.

The operation display unit 30 configured as described above receives a touch operation on the touchscreen 313 by the user as an input operation. The operation display unit 30 converts the input operation into an operation signal and outputs the operation signal to the controller 10. The operation display unit 30 also performs the vibration action with the vibrator 32 and the notification-sound output action with the notification-sound outputter 33 in response to the received input operation.

The scanner 40 shown in FIG. 1 includes an automatic document conveyor, an image reader, a placing tray, and a platen glass. The automatic document conveyor includes: the placing tray on which sheets are placed; and a conveying mechanism and a conveying roller(s) for conveying the sheets. The automatic document conveyor conveys the sheets along a predetermined conveying path. The image reader includes a optical system, such as a light source and a reflective mirror, and an imaging element. The image reader reads an image formed on the sheet that is conveyed along the conveying path or that is placed on the platen glass, to generate bitmapped image data for the respective colors of R (red), G (green), and B (blue). The scanner 40 reads an image on a sheet to generate image data and stores the data in the storage 13 shown in FIG. 4, under the control of the controller 10. The scanner 40 that performs image reading operation is a processing performer that performs processing involving outputting both processing sounds and vibration.

FIG. 4 is a block diagram showing main functional components of the image forming apparatus 1.

The image forming apparatus 1 includes: the controller 10; the image former 20; the operation display unit 30 that includes the display 31, the vibrator 32, the notification-sound outputter 33, and the sound collector 34; the scanner 40; the communication unit 50; and a bus 60. The display 31 includes the display panel 311, the display-panel driver 312, the touchscreen 313, and the touchscreen driver 314. The vibrator 32 includes the vibration element 321 and the vibration driver 322. The notification-sound outputter 33 includes the speaker 331 and the speaker driver 332. The components of the image forming apparatus 1 are connected via the bus 60.

The controller 10 and the operation display unit 30 constitute the input device 2. The components that have already been described are not described below.

The controller 10 includes a central processing unit (CPU) 11, a random access memory (RAM) 12, and a storage 13. The CPU 11 of the controller 10 executes programs 131 stored in the storage 13 to perform various kinds of processing, thereby functioning as a display control unit and vibration control unit.

The CPU 11 reads and executes the programs 131 stored in the storage 13 to perform various arithmetic processes.

The RAM 12 provides a working memory space for the CPU 11 and stores temporary data.

The storage 13 consists of a nonvolatile storage, such as a hard disk drive (HDD), a solid state drive (SSD), and/or a flash memory. The storage 13 stores the programs 131 to be performed by the CPU 11 and various kinds of data. The data to be stored in the storage 13 includes: image data obtained by the scanner 40; image data input from outside via the communication unit 50; response setting data 132 (response setting information); a set-value correction table 133; and a set-value addition table 134.

The response setting data 132 includes setting on whether or not to perform the vibration action with the vibrator 32 and the notification-sound output action with the notification-sound outputter 33.

The set-value correction table 133 is table data that is referred to in correcting (i) the set value for the vibration intensity of the vibration action by the vibrator 32 and (ii) the set value for the sound volume of the notification-sound output action by the notification-sound outputter 33 according to the level of the ambient sound.

The set-value addition table 134 is referred to in correcting (i) the set value for the vibration intensity of the vibration action by the vibrator 32 and (ii) the set value for the sound volume of the notification-sound output action by the notification-sound outputter 33 according to the operating state of the image former 20 and the scanner 40.

The correction of the set values of the vibration intensity and the sound volume is described later.

The controller 10, which includes the CPU 11, the RAM 12, and the storage 13, centrally controls the components of the image forming apparatus 1 in accordance with the programs 131.

For example, the controller 10 activates the components of the image former 20 to form images on sheets on the basis of the image data stored in the storage 13.

The controller 10 also sends a control signal to the display-panel driver 312 to display the operation window, the status window, and so forth on the display panel 311.

The controller 10 also sends a control signal to the touchscreen driver 314 and receives a detection signal from the touchscreen driver 314 to detect the touch performed with the operation tool on the operation surface 313a of the touchscreen 313 and the touched position.

The controller 10 also sends a control signal to the vibration driver 322 to vibrate the vibration element 321 at an appropriate timing, intensity and vibration pattern.

The controller 10 also sends a control signal to the speaker driver 332 to output the notification sound from the speaker 331 at an appropriate timing and volume.

The communication unit 50 includes a network card. The communication unit 50 is connected to a communication network, such as a local area network (LAN), and sends and receives data to and from external apparatuses over the network. Via the communication unit 50, the controller 10 communicates with external apparatuses over the communication network.

[Operation of Image Forming Apparatus]

The operation of the image forming apparatus 1 is described. The description is mainly on the vibration action by the vibrator 32 and the notification-sound output action by the notification-sound outputter 33 in response to the touch operation on the touchscreen 313.

<1. Setting on Whether or not to Perform Vibration Action and Notification-Sound Output Action>

The image forming apparatus 1 in this embodiment allows the user to determine whether or not to perform the vibration action with the vibrator 32 (i.e., vibration response) and the notification-sound output action with the notification-sound outputter 33 (i.e., sound response) when detecting a touch operation on the operation surface 313a.

The setting on whether or not to perform the vibration action and the notification-sound output action can be done on the response setting window 311a.

FIG. 5 shows the response setting window 311a.

The response setting window 311a is displayed on the display panel 311 in response to a certain input operation by the user. The response setting window 311a includes: a vibration-response slide button 3111 for setting whether or not to perform the vibration action; and a sound-response slide button 3112 for setting whether or not to perform the notification-sound output action.

By switching the slide button 3111 to “ON” with a certain input operation, the operation display unit 30 is set to perform the vibration action in response to a touch operation. By switching the slide button 3111 to “OFF”, the operation display unit 31 is set not to perform the vibration action in response to a touch operation. Further, by switching the slide button 3112 to “ON”, the operation display unit 30 is set to perform the notification-sound output action in response to a touch operation. By switching the slide button 3112 to “OFF”, the operation display unit 31 is set not to perform the notification-sound output action in response to a touch operation.

The content of the setting in the response setting window 311a is stored in the response setting data 132.

<2. Adjustment of Default Value of Vibration Intensity and Sound Volume>

The response setting data 132 stores set values for the vibration intensity of the vibration action and set values for the sound volume of the notification-sound output action, in addition to the setting on whether or not to perform the vibration action and the notification-sound output action.

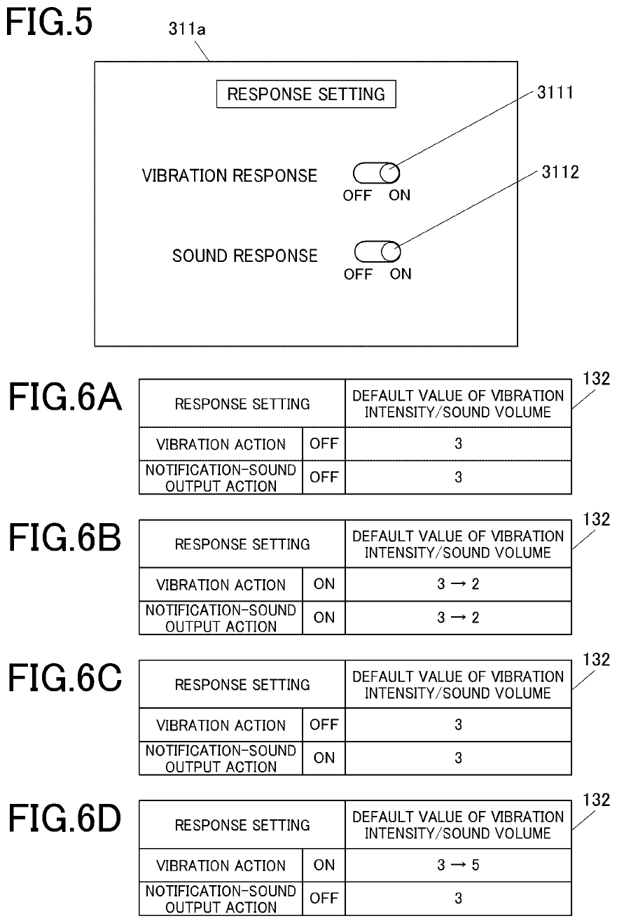

FIGS. 6A, 6B, 6C, 6D show examples of contents of the response setting data 132.

As shown in FIG. 6A, the response setting data 132 includes: the setting on whether or not to perform the vibration response (ON/OFF); the setting on whether or not to perform the notification-sound output response (ON/OFF); the default value of the vibration intensity of the vibration action; and the default value of the sound volume of the notification-sound output action. Herein, the default values refer to the values before additional values are added by the user. The additional values are described later. When the additional value is input by the user, the total of the default value and the additional value becomes the set value.

The greater the set value of the vibration intensity is, the greater the vibration intensity of the vibration action is. The greater the set value of the sound volume is, the greater the sound volume of the notification-sound output action is.

In this embodiment, the default values of the vibration intensity and the sound volume are automatically set depending on the setting on whether or not to perform the vibration action and the notification-sound output action.

When the image forming apparatus 1 is delivered, the default values of the vibration intensity and the sound volume are set to a reference value “3”, as shown in FIG. 6A.

When both the vibration action and the notification-sound output action are allowed to be performed, the default values of the vibration intensity and the sound volume are set to “2”, which is less than the reference value, as shown in FIG. 6B. When both the vibration action and the notification-sound output action are performed, the sound response by the notification-sound output action plays a main role in responding to a touch operation, while the vibration intensity may be relatively low. The default value of the vibration intensity is therefore set to a value smaller than the reference value. As the sound response and the vibration response are performed together, it is not necessary to increase the volume of the notification sound. The default value of the sound volume is therefore set to a value smaller than the reference value.

When only the notification-sound output action is allowed to be performed, the default values of the vibration intensity and the sound volume are unchanged from the reference value “3”, as shown in FIG. 6C. This is because the notification sound at the reference sound volume can be sensed by the user unless the ambient sound is extremely large. It is therefore not necessary to increase the volume of the notification sound. However, the default value of the notification-sound output action may be set to a value greater than the reference value, so as to avoid the situation in which the notification sound is less audible due to the ambient sound.

In FIG. 6C, although the default value of the vibration intensity is set to the reference value “3”, the vibration action is not performed as it is set to OFF.

When only the vibration action is allowed to be performed, the default value of the vibration action is adjusted to “5”, which is greater than the reference value, as shown in FIG. 6D. When only the vibration action is performed, only the vibration response is sent in response to the touch operation. The vibration response, which is sensed by the finger, may be sensed differently from user to user. The default value of the vibration intensity is therefore set to be greater than the reference value so that a user who is less sensitive to the vibration response can certainly sense the vibration.

In FIG. 6D, although the default value of the sound volume is set to the reference value “3”, the notification-sound output action is not performed as it is set to OFF.

As described above, in this embodiment, when the vibration action and the notification-sound output action are allowed to be performed (FIG. 6B), the default value of the sound volume is adjusted to be smaller than that when only the notification-sound output action is allowed to be performed (FIG. 6C).

Further, when the vibration action and the notification-sound output action are allowed to be performed (FIG. 6B), the default value of the vibration intensity is adjusted to be smaller than that when only the vibration action is allowed to be performed (FIG. 6D).

Further, when only the vibration action is allowed to be performed (FIG. 6D), the default value of the vibration intensity is adjusted to be greater than that when both the vibration action and the notification-sound output action are performed (FIG. 6B).

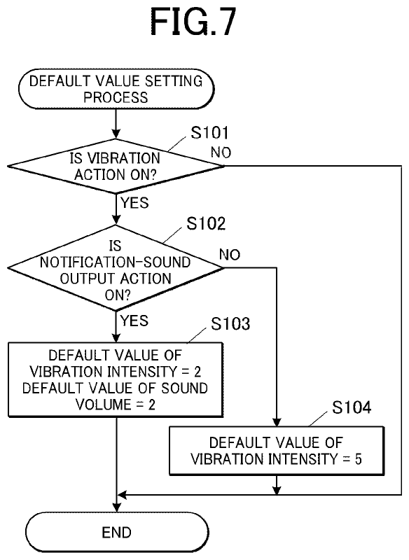

FIG. 7 shows control procedure of a default-value setting process for setting the default values of the vibration intensity and the sound volume. The process is performed by the controller 10.

At the start of the default-value setting process, the default values of the vibration intensity and the sound volume are both set to the reference value “3”.

When the default-value setting process starts, the controller 10 determines whether or not the vibration action is set to ON in the response setting window 311a (Step S101). When determining that the vibration action is set to ON (Step S101: YES), the controller 10 determines whether or not the notification-sound output action is set to ON (Step S102). When determining that the notification-sound output action is set to ON (Step S102: YES), the controller 10 sets, in the response setting data 132, the default value of the vibration intensity to “2” and the default value of the sound volume to “2” (Step S103).

When determining that the notification-sound output action is set to OFF (Step S102: NO), the controller 10 sets, in the response setting data 132, the default value of the vibration intensity to “5” (Step S104).

After Step S103 or S104, the controller 10 ends the default-value setting process.

When determining that the vibration action is set to OFF (Step S101: NO), the controller 10 ends the default-value setting process without changing the default value.

Next, a method of adjusting the vibration intensity and the sound volume by the user is described.

The image forming apparatus 1 in this embodiment allows the user to adjust the vibration intensity of the vibration action performed by the vibrator 32 and the sound volume of the notification-sound output action perfarmed by the notification-sound outputter 33 to a desired intensity and volume.

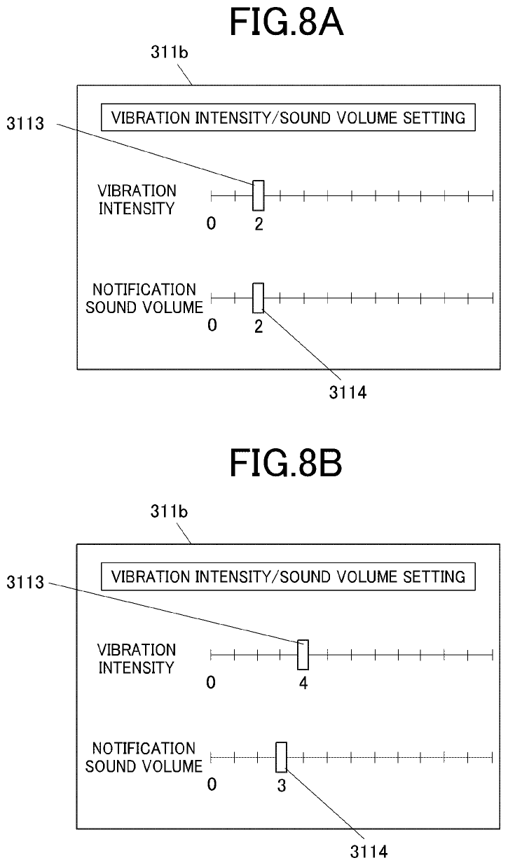

FIGS. 8A, 8B show a set-value change window 311b for receiving the user's operation of adjusting the vibration intensity and sound volume.

The set-value change window 311b is displayed on the display panel 311 in response to a certain input operation by the user. The set-value change window 311b has: a slide bar 3113 for changing the set value of the vibration intensity of the vibration response; and a slide bar 3114 for changing the set value of the sound volume of the notification-sound output action.

As shown in FIG. 8A, when the set-value change window 311b is displayed, the slide bars 3113, 3114 both indicate their respective default values that have been set in the default-value setting process. FIG. 8A shows the case where both the vibration action and the notification-sound output action are both set to ON, as in FIG. 6B. The slide bars 3113 far the vibration intensity and the slide bar 3114 for the sound volume are both positioned at the default value “2”.

The slide bars 3113, 3114 can be moved to the right or left by being dragged, for example, so that the set values of the vibration intensity and the sound volume are changed to the set values after being moved.

FIG. 8B shows the case where the set value of the vibration intensity has been changed from “2” to “4”. That is, the user has added the additional value “2” to the default value “2”, which yields the set value “4”.

In FIG. 8B, the set value of the sound volume has also been change from “2” to “3”. That is, the user has added the additional value “1” to the default value “2”, which yields the set value “3”.

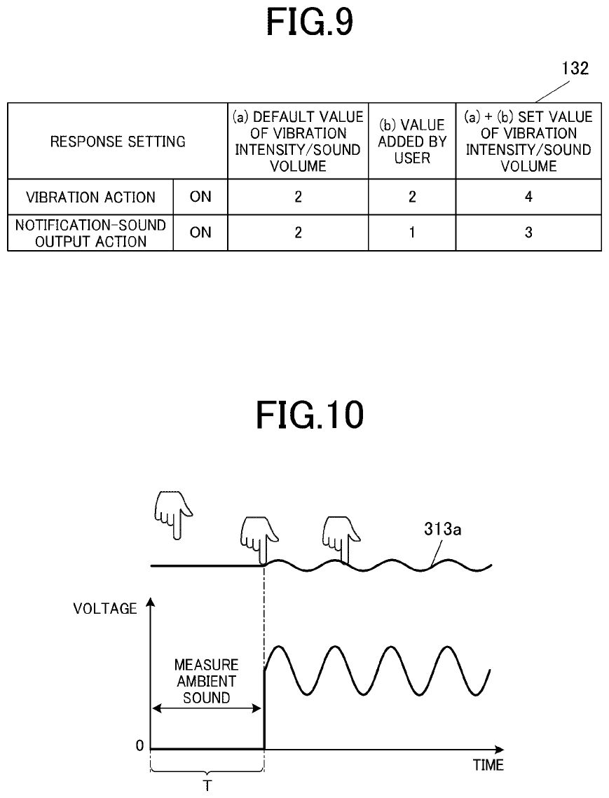

FIG. 9 shows the response setting data 132 that stores the set values on which the additional values have been reflected.

As shown in FIG. 9, for each of the vibration intensity and the sound volume, the sum of the default value (a) and the user's additional value (b) is the set value (a)±(b). When the response setting data 132 shown in FIG. 9 is stored in the storage 13 and the touch operation is performed on the operation surface 313a, the operation display unit 30 performs the vibration action and/or and the notification-sound output action at the vibration intensity/sound volume corresponding to the set value (a) (b).

Thus, the setting of the vibration intensity and the sound volume consists of (i) additional setting by the user and (ii) default setting that does not include the additional setting.

There may be a case where the user inputs the additional values and then changes the setting on whether or not to perform the vibration action and the notification-sound output action in the response setting window 311a in FIG. 5. In the case, the default-value setting process in FIG. 7 is performed again, and according to the result of the process, the default values (a) in the response setting data 132 in FIG. 9 are changed. Thus, even after the additional values are input, the set values of the vibration intensity and the sound volume are adjusted according to the setting on whether or not to perform the vibration action and the notification-sound output action.

When the setting on whether or not to perform the vibration action and the notification-sound output action are changed while the additional values remain unchanged, the set values of the vibration intensity and the sound volume satisfy the following (i) to (iii).

(i) When the vibration action and the notification-sound output action are allowed to be performed (FIG. 6B), the set value of the sound volume is adjusted to be smaller than that when only the notification-sound output action is allowed to be performed (FIG. 6C).

(ii) When the vibration action and the notification-sound output action are allowed to be performed (FIG. 6B), the set value of the vibration intensity is adjusted to be smaller than that when only the vibration action is allowed to be performed (FIG. 6D).

(iii) When only the vibration action is allowed to be performed (FIG. 6D), the set value of the vibration intensity is adjusted to be greater than that when both the vibration action and the notification-sound output action are allowed to be performed (FIG. 6B).

<3. Adjustment of Set Values According to Ambient Sound>

Next, a method of adjusting the set values of the vibration intensity and the sound volume according to the level of the ambient sound around the image forming apparatus 1 is described.

When the ambient sound (noise) around the image forming apparatus 1 is large, the notification sound output by the notification-sound outputter 33 may not be sensed by the user. It is therefore preferable that the set value for the volume of the notification sound be increased so that the user can certainly sense the notification sound. It is further preferable that the set value for the vibration intensity be increased on the assumption that the notification sound may not be properly sensed by the user. The image forming apparatus 1 measures the level of the ambient sound with the sound collector 34. On the basis of the measurement result, the image forming apparatus 1 corrects the set values of the vibration intensity and the sound volume.

FIG. 10 is a figure to explain how the set values of the vibration intensity and the sound volume are corrected according to the level of the ambient sound.

The upper part of FIG. 10 shows the touch operation on the operation surface 313a and the vibration of the operation surface 313a. The lower part of FIG. 10 shows the driving waveform that is applied to the vibration element 321.

The image forming apparatus 1 measures, with the sound collector 34, the level of the ambient sound in the period T in which the touch operation is not performed on the operation surface 313a. The measurement result is output to the controller 10. When the touch operation is performed on the operation surface 313a, the set values of the vibration intensity and the sound volume are corrected (adjusted) according to the result of measuring the ambient sound at the timing of the touch operation (i.e., at the timing when the period T ends). The vibration action and/or the notification-sound output action is then performed at the intensity/volume corresponding to the corrected (adjusted) set values. The correction of the set values according to the level of the ambient sound is done with the set-value correction table 133.

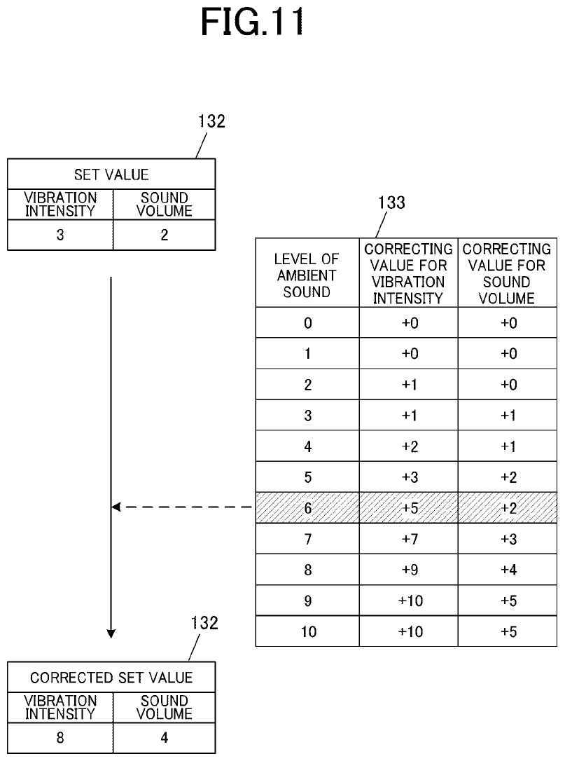

FIG. 11 is a figure to explain how the set values are corrected with the set-value correction table 133.

Assume that, at the timing of the touch operation, the set value of the vibration intensity is “3” and the set value of the sound volume is “2” in the response setting data 132, as shown in the upper part of FIG. 11.

The set-value correction table 133 shown in the right in FIG. 11 is table data that records correcting values for correcting the set values of the vibration intensity and the sound volume in association with the levels of the ambient sound. The ambient sound is classified into 11 levels (volumes) from 0 to 10. When the level of the ambient sound is determined, the correcting value that corresponds to the determined level of the ambient sound is added to the current set value in the response setting data 132. The set value is thus corrected.

The correcting value for correcting the set value of the vibration intensity is set to be greater for a higher level of the ambient sound. Accordingly, the set value of the vibration intensity is corrected such that the vibration intensity of the vibration action is greater for a greater ambient sound detected.

The correcting value for correcting the set value of the sound volume is also set to be greater for a higher level of the ambient sound. Accordingly, the set value of the sound volume is corrected such that the sound volume of the notification-sound output action is greater for a greater ambient sound detected.

For example, assume that the level of the ambient sound is determined as “6”. The correcting values that correspond to the level “6” for the set values of the vibration intensity and the sound volume are “+5” and “+2”, respectively. These correcting values are added to the set value of the vibration intensity “3” and the set value of the sound volume “2” in the response setting data 132, respectively. As a result, the set value of the vibration intensity is corrected to “8”, and the set value of the sound volume is corrected to “4”, as shown in the lower part of FIG. 11.

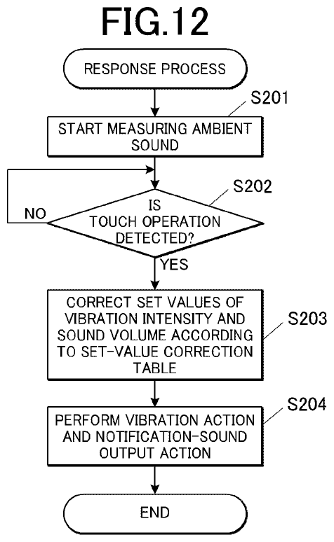

FIG. 12 is a flowchart showing control procedure of a response process that is performed by the controller 10. The response process includes correcting the set values according to the ambient sound.

When the response process starts, the controller 10 causes the sound collector 34 to measure the level of the ambient sound (Step S201).

The controller 10 determines whether or not the touch operation on the operation surface 313a of the touchscreen 313 is detected (Step S202). When determining that the touch operation is not detected (Step S202: NO), the controller 10 repeats Step S202. When determining that the touch operation is detected (Step S202: YES), the controller 10 corrects the set values of the vibration intensity and the sound volume according to the set-value correction table 133, and stores the corrected set values in the response setting data 132 (Step S203). The controller 10 causes the vibrator 32 to perform the vibration action at the intensity corresponding to the corrected value and causes the notification-sound outputter 33 to perform the notification-sound output action at the sound volume corresponding to the corrected value (Step S204).

After Step S204, the controller 10 ends the response process.

<4. Adjustment of Set Values According to Operating State of Image Forming Apparatus>

Next, a method of adjusting the set values of the vibration intensity and the sound volume according to the operating state of the image forming apparatus 1 is described.

When the image former 20 and/or the scanner 40 (processing performers) are active in the image forming apparatus 1, the image forming apparatus 1 itself generates vibration and processing sounds. With the vibration and sounds, the user may be less sensitive to the vibration of the operation surface 313a by the vibrator 32 and the notification sound by the notification-sound outputter 33. It is therefore preferable that the set values of the vibration intensity and the sound volume be increased so that the user can certainly sense the vibration and the notification sound.

The image forming apparatus 1 is configured to correct the set values of the vibration intensity and the sound volume according to the operating state of the image former 20 and the scanner 40.

More specifically, when the image former 20 and/or the scanner 40 is performing processing, the set value of the vibration intensity is corrected to be greater than that when the image former 20 and/or the scanner 40 is not performing processing.

Further, when the image former 20 and/or the scanner 40 is performing processing, the set value of the sound volume is corrected to be greater than that when the image former 20 and/or the scanner 40 is not performing processing.

The correction of the set values according to the operating state of the image former 20 and the scanner 40 is done using the set-value addition table 134.

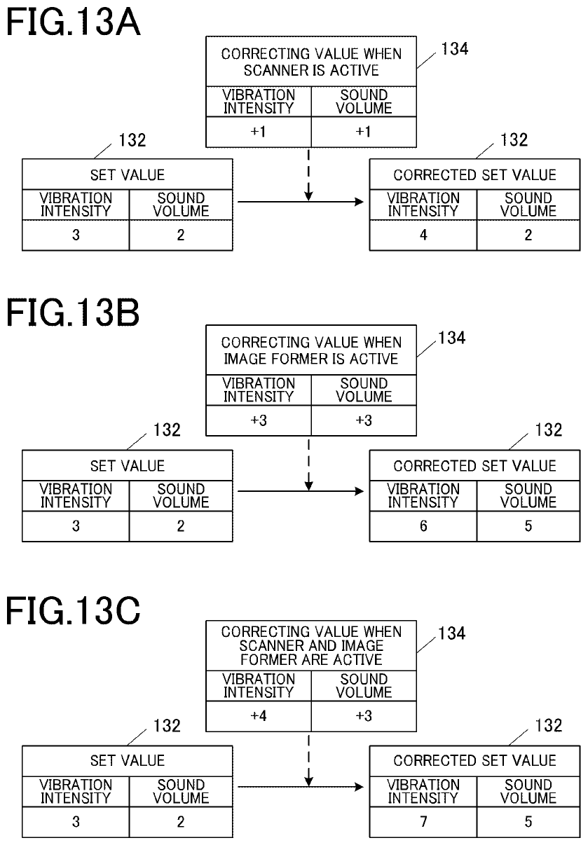

FIG. 13 is a figure to explain how the set values are corrected with the set-value addition table 134.

Assume that, at the timing of the touch operation, the set value of the vibration intensity is “3” and the set value of the sound volume is “2” in the response setting data 132, as shown in the left part of FIG. 13A.

The set-value addition table 134 in the center of FIG. 13A indicates that, when the scanner 40 is active, the correcting values for the set values of the vibration intensity and the sound volume are “+1” and “+1”, respectively. When the scanner 40 is active, these correcting values are added to the respective set values “3” and “2” of the vibration intensity and the sound volume in the response setting data 132. As a result, the set values of the vibration intensity and the sound volume are corrected to “4” and “3”, respectively as shown in the right in FIG. 13A.

The set-value addition table 134 in the center of FIG. 13B indicates that, when the image former 20 is active, the correcting values for the set values of the vibration intensity and the sound volume are “+3” and “+3”, respectively. When the image former 20 is active, these correcting values are added to the respective set values “3” and “2” of the vibration intensity and the sound volume in the response setting data 132. As a result, the set values of the vibration intensity and the sound volume are corrected to “6” and “5”, respectively as shown in the right in FIG. 13B.

The set-value addition table 134 in the center of FIG. 13C indicates that, when the scanner 40 and the image former 20 are active, the correcting values for the set values of the vibration intensity and the sound volume are “+4” and “+3”, respectively. When the scanner 40 and the image former 20 are active, these correcting values are added to the respective set values “3” and “2” of the vibration intensity and the sound volume in the response setting data 132. As a result, the set values of the vibration intensity and the sound volume are corrected to “7” and “5”, respectively as shown in the right in FIG. 13C.

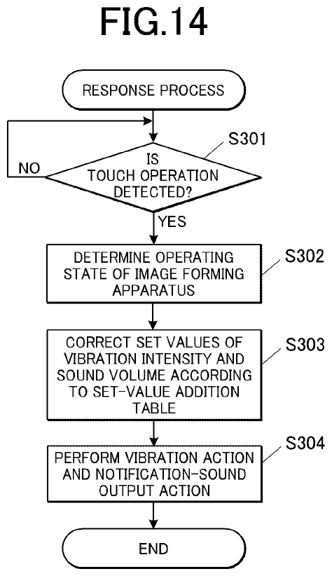

FIG. 14 is a flowchart showing control procedure of the response process to be performed by the controller 10. The process includes correction of the set values according to the operating state of the image forming apparatus 1.

When the response process starts, the controller 10 determines whether or not the touch operation on the operation surface 313a of the touchscreen 313 is detected (Step S301). When determining that the touch operation is not detected (Step S301: NO), the controller 10 repeats Step S301.

When determining that the touch operation is detected (Step S301: YES), the controller 10 determines the operating state of the image former 20 and the scanner 40 of the image forming apparatus 1 (Step S302). The controller 10 corrects the set values of the vibration intensity and the sound volume on the basis of the determination result in Step S302 and the set-value addition table 134, and stores the corrected set values in the response setting data 132 (Step S303). The controller 10 causes the vibrator 32 to perform the vibration action at the intensity corresponding to the corrected value and causes the notification-sound outputter 33 to perform the notification-sound output action at the sound volume corresponding to the corrected value (Step S304).

After Step S304, the controller 10 ends the response process.

The correction of the set values may be done in consideration of the level of the ambient sound described above, as well as the operating state of the image forming apparatus 1. In the case, the set values may be corrected by adding the correcting values in the set-value correction table 133 and the correcting values in the set-value addition table 134, for example.

As described above, the image forming apparatus 1 according to this embodiment includes: the display 31 with the touchscreen 313; the vibrator 32 configured to perform the vibration action of vibrating the operation surface 313a of the touchscreen 313; the notification sound outputter 33 configured to perform the notification-sound output action of outputting a notification sound; the storage 13 that stores the response setting data 132 on whether the vibration action and the notification-sound action are enabled; and the controller 10 that causes the vibrator 32 and/or the notification sound outputter 33 to perform the vibration action and/or the notification-sound output action enabled in the response setting data 132 in response to a touch operation on the operation surface 313a. The controller 10 adjusts the vibration intensity of the vibration action and the sound volume of the notification-sound output action according to at least either the response setting data 132 or the operating state of the image forming apparatus 1.

According to this configuration, the image forming apparatus 1 can vibrate the vibrator 32 at an appropriate vibration intensity and output the notification sound at an appropriate sound volume with the notification-sound outputter 33, on the basis of the setting on whether or not to perform the vibration response and the sound response and the operating state of the image forming apparatus 1. The image forming apparatus 1 thus can respond to the touch operation more certainly without annoying the user.

Further, the controller 10 adjusts the sound volume such that the sound volume when both the vibration action and the notification-sound output action are enabled in the response setting data 132 is smaller than the sound volume when only the notification-sound output action is enabled. According to this configuration, the image forming apparatus 1 can reduce the volume of the notification sound within a range of certainly transmitting a response to the touch operation to the user. Accordingly, the image forming apparatus 1 can avoid causing discomfort due to a too loud notification sound.

Further, the controller 10 adjusts the vibration intensity such that the vibration intensity when both the vibration action and the notification-sound output action are enabled in the response setting data 132 is lower than the vibration intensity when only the vibration action is enabled. According to this configuration, the image forming apparatus 1 can reduce the vibration intensity within a range of certainly transmitting a response to the touch operation to the user. Accordingly, the image forming apparatus 1 can avoid causing discomfort due to too strong vibration of the operation surface 313a.

Further, the controller 10 adjusts the vibration intensity such that the vibration intensity when only the vibration action is enabled in the response setting data 132 is higher than the vibration intensity when both the vibration action and the notification-sound output action are enabled. Accordingly, when the notification sound is not output, the image forming apparatus 1 can more certainly transmit the vibration response to the user with the vibration action of the vibrator 32.

Further, the image forming apparatus 1 includes the sound collector 34 that detects the volume of an ambient sound. According to the volume of the ambient sound detected by the sound collector 34, the controller 10 adjusts the vibration intensity of the vibration action such that the vibration intensity is higher for the larger ambient sound detected. According to this configuration, when the notification sound output by the notification-sound outputter 33 is less audible owing to the ambient sound, the image forming apparatus 1 can more certainly transmit the vibration response to the user in response to the touch operation.

Further, according to the volume of the ambient sound detected by the sound collector 34, the controller 10 adjusts the sound volume of the notification-sound output action such that the sound volume is larger for the larger ambient sound detected. According to this configuration, when the notification sound output by the notification-sound outputter 33 is less audible owing to the ambient sound, the image forming apparatus 1 can more certainly transmit the sound response to the user in response to the touch operation.

Further, the image forming apparatus 1 includes the image former 20 and the scanner 40 as a processing performer that is configured to perform certain processing that involves at least a processing sound or vibration. According to the operating state of the image former 20 and the scanner 40, the controller 10 adjusts the vibration intensity of the vibration action such that the vibration intensity when the image former 20 and/or the scanner 40 is performing the processing is higher than the vibration intensity when the image former 20 and/or the scanner 40 is not performing the processing. According to this configuration, when the notification sound output by the notification-sound outputter 33 is less audible owing to the effects of the operating sound and vibration of the image former 20 and/or the scanner 40, the image forming apparatus 1 can more certainly transmit the vibration response to the user in response to the touch operation.

Further, according to the operating state of the image former 20 and the scanner 40, the controller 10 adjusts the sound volume of the notification-sound output action such that the sound volume when the image former 20 and/or the scanner 40 is performing the processing is larger than the sound volume when the image former 20 and/or the scanner 40 is not performing the processing. According to this configuration, when the notification sound output by the notification-sound outputter 33 is less audible owing to the effects of the operating sound and vibration of the image former 20 and/or the scanner 40, the image forming apparatus 1 can more certainly transmit the sound response to the user in response to the touch operation.

Further, in this embodiment, the method for adjusting operation of the image forming apparatus 1 as the information processing apparatus includes: adjusting the vibration intensity of the vibration action and the sound volume of the notification-sound output action according to at least either the response setting data 132 or the operating state of the image forming apparatus 1; and causing the vibrator 32 and/or the notification sound outputter 33 to perform the vibration action and/or the notification-sound output action enabled in the response setting data 132 in response to a touch operation on the operation surface 313a. According to this configuration, the image forming apparatus 1 can vibrate the vibrator 32 at an appropriate vibration intensity and output the notification sound at an appropriate sound volume with the notification-sound outputter 33, on the basis of the setting on whether or not to perform the vibration response and the sound response and the operating state of the image forming apparatus 1. The image forming apparatus 1 thus can respond to the touch operation more certainly without annoying the user.

Further, in this embodiment, the program 131 causes a computer of the image forming apparatus 1 as the information processing apparatus to function as the controller 10 that: causes the vibrator 32 and/or the notification sound outputter 33 to perform the vibration action and/or the notification-sound output action enabled in the response setting data 132 in response to a touch operation on the operation surface 132a; and adjusts the vibration intensity of the vibration action and the sound volume of the notification-sound output action according to at least either the response setting data 132 or the operating state of the image forming apparatus 1. According to the program 131 for operating the image forming apparatus 1, the image forming apparatus 1 can vibrate the vibrator 32 at an appropriate vibration intensity and output the notification sound at an appropriate sound volume with the notification-sound outputter 33, on the basis of the setting on whether or not to perform the vibration response and the sound response and the operating state of the image forming apparatus 1. The image forming apparatus 1 thus can respond to the touch operation more certainly without annoying the user.

The above embodiment and modification examples do not limit the present invention and can be variously modified.

For example, either the adjustment of the set values according to the ambient sound or the adjustment of the set values according to the operating state of the processing performers may be omitted.

Further, the correcting values in the set-value correction table 133 and the set-value addition table 134 may be changed by the user. Further, the response setting data 132, the set-value correction table 133, and the set-value addition table 134 may be prepared for each user. In the case, the set values of the vibration intensity and the sound volume may be adjusted on the basis of the response setting data 132, the set-value correction table 133, and the set-value addition table 134 that correspond to the user using the image forming apparatus 1.

Further, although the notification-sound outputter 33 is provided near the display 31 as an example in FIG. 3, this is not the limitation. The notification-sound outputter 33 may be provided at any place from which the notification sound can be certainly transmitted to the user operating the image forming apparatus 1.

Further, at least the display 31 and the vibrator 32 in the operation display unit 30 may be mounted on an operation terminal that is attachable to and detachable from the housing 1a of the image forming apparatus 1. In the case, the terminal may be configured to receive the touch operation even when detached from the image forming apparatus 1.

Further, the processing performer is not limited to the image former 20 and the scanner 40 described above. The processing performer can be any mechanism that performs processing involving at least either processing sounds or vibration.

Although the embodiment of the present invention has been described and illustrated in detail, the scope of the present invention is not limited to the embodiments described above but encompasses the scope of the invention recited in the claims and the equivalent thereof. The disclosed embodiment is made for purposes of illustration and example only and not limitation. The scope of the present invention should be interpreted by terms of the appended claims.

What is claimed is:

1. An information processing apparatus comprising:
a display with a touchscreen;
a vibrator configured to perform a vibration action of vibrating an operation surface of the touchscreen:
a notification sound outputter configured to perform a notification-sound output action of outputting a notification sound;
a storage that stores response setting information on whether the vibration action and the notification-sound action are enabled; and
a hardware processor that causes the vibrator and/or the notification sound outputter to perform the vibration action and/or the notification-sound output action enabled in the response setting information in response to a touch operation on the operation surface, wherein
the hardware processor adjusts a vibration intensity of the vibration action and a sound volume of the notification-sound output action according to at least either the response setting information or an operating state of the information processing apparatus.

2. The information processing apparatus according to claim 1, wherein
the hardware processor adjusts the sound volume such that the sound volume when both the vibration action and the notification-sound output action are enabled in the response setting information is smaller than the sound volume when only the notification-sound output action is enabled.

3. The information processing apparatus according to claim 1, wherein
the hardware processor adjusts the vibration intensity such that the vibration intensity when both the vibration action and the notification-sound output action are enabled in the response setting information is lower than the vibration intensity when only the vibration action is enabled.

4. The information processing apparatus according to claim 1, wherein
the hardware processor adjusts the vibration intensity such that the vibration intensity when only the vibration action is enabled in the response setting information is higher than the vibration intensity when both the vibration action and the notification-sound output action are enabled.

5. The information processing apparatus according to claim 1, further comprising an ambient sound detector that detects a volume of an ambient sound, wherein
according to the volume of the ambient sound detected by the ambient sound detector, the hardware processor adjusts the vibration intensity of the vibration action such that the vibration intensity is higher for the larger ambient sound detected.

6. The information processing apparatus according to claim 1, further comprising an ambient sound detector that detects a volume of an ambient sound, wherein
according to the volume of the ambient sound detected by the ambient sound detector, the hardware processor adjusts the sound volume of the notification-sound output action such that the sound volume is larger for the larger ambient sound detected.

7. The information processing apparatus according to claim 1, further comprising a processing performer configured to perform certain processing that involves at least a processing sound or vibration, wherein
according to the operating state of the processing performer, the hardware processor adjusts the vibration intensity of the vibration action such that the vibration intensity when the processing performer is performing the processing is higher than the vibration intensity when the processing performer is not performing the processing.

8. The information processing apparatus according to claim 1, further comprising a processing performer configured to perform certain processing that involves at least a processing sound or vibration, wherein
according to the operating state of the processing performer, the hardware processor adjusts the sound volume of the notification-sound output action such that the sound volume when the processing performer is performing the processing is larger than the sound volume when the processing performer is not performing the processing.

9. A method for adjusting an operation of an information processing apparatus that includes: a display with a touchscreen; a vibrator configured to perform a vibration action of vibrating an operation surface of the touchscreen; a notification sound outputter configured to perform a notification-sound output action of outputting a notification sound; and a storage storing response setting information on whether the vibration action and the notification-sound action are enabled, the method comprising:
adjusting a vibration intensity of the vibration action and a sound volume of the notification-sound output action according to at least either the response setting information or an operating state of the information processing apparatus; and
causing the vibrator and/or the notification sound outputter to perform the vibration action and/or the notification-sound output action enabled in the response setting information in response to a touch operation on the operation surface.

10. A non-transitory computer-readable storage medium storing a program that causes a computer of an information processing apparatus including: a display with a touchscreen; a vibrator configured to perform a vibration action of vibrating an operation surface of the touchscreen; a notification sound outputter configured to perform a notification-sound output action of outputting a notification sound; and a storage storing response setting information on whether the vibration action and the notification-sound action are enabled, to function as a hardware processor that
causes the vibrator and/or the notification sound outputter to perform the vibration action and/or the notification-sound output action enabled in the response setting information in response to a touch operation on the operation surface and
adjusts a vibration intensity of the vibration action and a sound volume of the notification-sound output action according to at least either the response setting information or an operating state of the information processing apparatus.
